(19) United States
(12) Patent Application Publication
(10) Pub. No.: US 2005/0267884 A1
(43) Pub. Date: Dec. 1, 2005

(54) Monotonic independent stack apparatus and methods for efficiently solving search problems

(76) Inventor: Shailendra Kumar Bhonsle, Fremont, CA (US)

Correspondence Address: DR. SHAILENDRA K. BHONSLE, 41873 HIGGINS WAY, FREMONT, CA, 94539, US

(21) Appl. No.: 11/053,739

(22) Filed: Feb. 7, 2005

Related U.S. Application Data
(60) Provisional application No. 60/542,411, filed on Feb. 6, 2004.

(51) Int. Cl. G06F 7/00

(52) U.S. Cl. 707/6

(57) ABSTRACT

Search for relevant information pervades all aspects of our daily personal and commercial interactions. Many commercial applications in the varied fields of multimedia, vision, semantics, multi-sensory systems, amongst others, require modeling data as a complex formal structure in which required information is searched for. Efficiency of such searches is an important discriminator of commercial use and success of these systems. This patent pertains to the design of an apparatus, Monotonic Independent Stack (MIS), and its operating methods. MIS contains a “stack” of “elements” extracted from the source and/or the target structure(s) in a monotonic ascending or descending order that are also pairwise “independent”. MIS operating methods always maintain both monotonicity and independence constraints for stack elements. MIS has been shown to drastically improve the performance of complex searches. Patent rights are claimed for the use of MIS in plurality of search processors under plurality of conditions.

This application continues the provisional patent application filed on Feb. 6, 2004, numbered 60/542,411, and entitled “Algorithmic methods and apparatus for solving the class of suborder-isomorphism problems for semiorders and related structures”. Claim 3 in this patent is specifically derived from that application.

### FIELD OF THE INVENTION

The present invention helps to improve the search efficiency of complex search engines. A generalized search engine typically needs to model source data as a formal structure in which a target structure is being sought. Search efficiency of such engines depends upon the structural complexity of the source as well as that of the target. The apparatus and methods of Monotonic Independent Stack (MIS) may be embedded in search engines that deal with complex structural searches.

### BACKGROUND OF THE INVENTION

Search for relevant information is an important and much studied topic. The current wide use of search engines in our daily interactions is giving rise to a number of commercial products. These systems deal with varying degrees of search complexities. The complexity of searching for intended target information in huge repositories of source data arises from a number of factors. The scale of source data is the most important factor. Other factors relate to the nature of the targeted information. For example, a complex search in a set of text documents may look for not only a set of words but also the order in which words occur with constraints on their relative positions. Such a search may be required if we desire to extract text documents through the “meaning” expressed in the document and not just through the juxtaposition of certain “keywords”. Searching for activities composed of primitive events in a surveillance video provides another example of a complex search. In fact, there are many desired complex search scenarios in the fields of, amongst others, multimedia systems, lexical semantics, image and video databases, and multi-sensory information systems.

The current state of the art is exemplified by keyword and key-phrase based search engines that are widely used to extract desired documents from a corpus of documents. Much commercial work is underway to enhance the state of the art to include search for targets that are structurally more complex than keywords and key-phrases. The main issues are how to model such a search in a given domain of application and also how efficiently such searches may be performed.

The reference provided and the bibliography contained there is a good source of information for many concepts involved in defining modeling of search problems and also for how efficiency of search processors is measured. For the purpose of this document, a model of search involves a source structure, S, that abstracts desired attributes of source data, and a target structure, T, that abstracts desired attributes of sought after target information. There is a plurality of modeling structures used in related research as well as in commercial products. This document only exemplifies a few of these structures. Typically, such structures are composed of a set of primitive elements, call them nodes, and a set of constraints that may be represented as binary relations, call them edges, between pairs of these nodes. The term order is typically used to represent such structures. Additionally, nodes and edges may have multiple values associated with them that may represent statistical or other parameters of the source data and the intended target information. Orders may be represented using graphs. In fact, all graphs are orders but not vice-versa. Subclasses of orders with their graph-like representations including partial orders, interval orders, semiorders, etc. are main classes of structures that we are interested in. For example, semiorders, and their corresponding graphs called indifference graphs, arise by denoting the set of equal-length intervals on a real line as nodes and appropriately representing pairwise non-intersecting intervals as edges. The reader is referred to a number of readily available textbooks on this topic as further details about the intricacies of these structures is not required to understand the main invention presented here. They are only required to understand the generic search framework in which the presented apparatus and its methods may be embedded.

Primary measures of efficiency of search engines are how much time they take to complete the given search task and how much working space they require to do so. Here we are mainly concerned with execution time efficiency. Typically, such time efficiency is measured as a function of sizes of the source and target structures, inputs to the generalized search framework. In general, execution time that is a “polynomial” function of input sizes is considered efficient. On the other hand, execution time that is an “exponential” function of input sizes is considered inefficient. In fact, many classes of search problems dealing with complex structures are open problems, i.e. no efficient process to conduct such searches is currently known.

Above paragraphs briefly describe the framework within which the invention is discussed. The apparatus of Monotonic Independent Stack (MIS) may be embedded inside a concrete realization of a generic search processor. Such a realization includes concrete definition of involved structures and operations that may be performed on them. The main “ideas” constituting MIS apparatus, described in the next section, is independent of the choice of any specific concrete realization of the search framework. In the reference provided and subsequent research, it is unequivocally shown how a subset of these “ideas” have helped efficiently solve a class of open search problems with structures as restricted as semiorders for which no known efficient solutions existed. The main intellectual property of this invention lies in additional methods that have since been added to enhance the MIS apparatus. With these enhancements, more efficient solutions have been demonstrated for certain classes of structures.

### SUMMARY OF THE INVENTION

A stack is a commonly used data structure in many computer programs and methods. Primarily it is used to maintain a collection of elements, for example that of numbers, and provides operations for inserting and deleting elements in a specialized manner. This collection of elements may be thought of as an ordered list, ordered by when and how they are added into the stack. A pointer to the top element of the stack is maintained during its operation. The main methods provided by a stack are push( ) and pop( ). Methods are indicated by suffixing “( )” to the name of a method throughout this document. The push( ) method inserts an element at the top of the stack and increments the top pointer to point to the new element. The pop( ) method removes and returns the element pointed to by the top pointer and modifies this pointer to point to the previous top element, if any. A stack could be empty, i.e. may not have any elements. In this case, pop( ) returns an error condition. This condition is indicated using keyword null throughout this document. The top pointer is null in an empty stack. Also, this typical stack is referred to as a “standard” stack in this document.

A brief behavioral description of the present invention of the Monotonic Independent Stack (MIS) apparatus and its methods is now presented. Details of the preferred embodiments are described in a later section. MIS may be used in two modes:
(1) As an independent apparatus, or
(2) Embedded inside other systems and used through its externally visible methods.

MIS consists of two standard stacks denoted by M and A. M is the main stack that contains externally visible data, whereas A is an auxiliary stack to support the operation of MIS. Elements stored in M maintain two important properties described below.
(1) They are monotonically ordered in ascending (increasing), or descending (decreasing) order of elements. An element operated upon by MIS has a special order attribute that is used to achieve monotonic ordering. Values of these attributes are distinct integers amongst all elements. A standard stack also has an ordered set of elements, but elements are ordered by when and how they are inserted into the stack and not by values attached to elements.
(2) They are pairwise independent. Independence between elements is primarily a binary relation between them. If MIS is embedded inside another apparatus then this relation is defined externally by the embedding system. FIG. 1 depicts MIS being used by a Generalized Search Processor (GSP). In this case, GSP supplies MIS with its elements as well as helps it decide if pairs of elements are independent. On the other hand, MIS may make certain independence decisions on its own when used alone based on certain attribute values attached to its elements.

MIS has the following two methods to achieve the monotonicity and independence conditions:
(1) comp( ) method which compares values of order attributes of two elements to decide their relative ordering, and
(2) ind( ) method which decides if two elements are independent of each other.

Method mpush( ) of MIS. The primary functionality of MIS is provided through its mpush( ) method. This method is responsible for updating its main stack M. This method is always called with a valid new element. The ordered list of elements stored in stack M, when mpush( ) is not currently executing, defines the stable state of MIS. An element outside of MIS is valid with respect to its stable state if and only if:
(1) it is independent of all elements in the stable state of MIS, and
(2) it has an order attribute value distinct from those of elements in the stable state of MIS.

Method mpush( ) operates in two phases:
(1) In phase 1, it selects a position for the new element in stack M. It discards elements above this position in M if they are not independent of the input element. It stores elements above this position that are independent of the input element in stack A. It then inserts the new element at the chosen position.
(2) In phase 2, elements stored in A are systematically restored to M so as to preserve the monotonic ordering property.

Embedded Operation of MIS and Embedding System. In embedded operation mode, MIS interacts with its embedding environment through use of its methods. Our primary focus is on the use of MIS in search problems. To this end, Generalized Search Processor (GSP) is an abstraction used to illustrate the use of MIS in such problems. A few related concepts were briefly described in the background section earlier. Concrete GSPs essentially solve instances of search problems that may be formulated as R=search(S, T). Here S is the source structure whereas T is the target structure that is being searched inside the source. R is the returned result that is a substructure of S“equal” (usually called “isomorphic” in relevant literature) to T. A null value for R indicates the failure of the search process. Details of any concrete GSP is outside the scope of this document. Provided reference and the bibliography included there provide an example of a concrete GSP scenario where partial use (only monotonicity condition but not independence between elements) of MIS was shown to substantially improve search performance. Nonetheless, it is illustrative to outline main functionalities that concrete GSPs must provide to utilize MIS. A few of these are listed below:
(1) A structure class must be chosen to represent S and T.
(2) GSP must decide what elements are, what their order attribute values should be, and how they are chosen from S before calling mpush( ) of MIS.
(3) GSP must decide on a criterion (or relationship) to be used as the independence relationship between elements.
(4) Finally a GSP should be able to effectively use MIS stable state, or the contents of its main stack M.

Finally, the non-obviousness and novelty of MIS apparatus and its methods are quite apparent. As indicated in the provided reference, even a partial use Oust the monotonicity condition and not that for independence) substantially improved the execution time efficiency for an open search problem for which no alternative solution is known. Subsequent application of MIS using both monotonicity and independence conditions made the search process even more efficient. A technical report on this result may be obtained from the author.

### BRIEF DESCRIPTION OF DRAWINGS

FIG. 1 depicts interactions between the Generalized Search Processor and the Monotonic Independent Stack apparatus.

FIG. 2 provides a flowchart of the operation of a Generalized Search Processor that uses methods of the Monotonic Independent Stack apparatus.

FIG. 3 enumerates essential parts of the Monotonic Independent Stack apparatus and its methods.

FIG. 4 provides a flowchart for the operation of the mpush( ) method of the Monotonic Independent Stack apparatus.

FIG. 5 exemplifies the behavior and the configuration of the Monotonic Independent Stack Apparatus assuming a simple concrete scenario for the Generalized Search Processor.

### DETAILED DESCRIPTIONS OF THE PREFERRED EMBODIMENTS

The invention is described in detail in this section with reference to accompanying diagrams. Although the main topic of discussion is the design and use of the apparatus of Monotonic Independent Stack (MIS), a brief discussion of a generalized search processor (GSP) that embeds this apparatus and uses its methods is provided first.

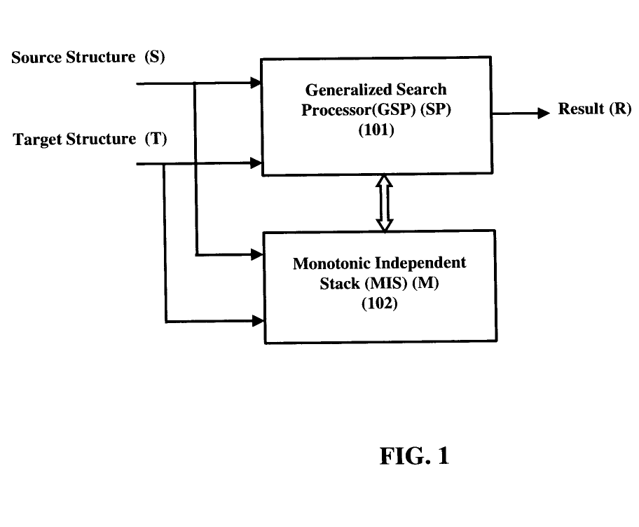

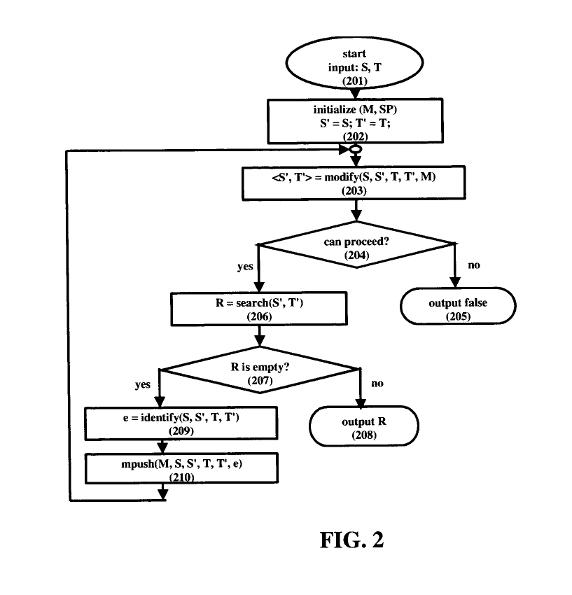

Generalized Search processor. FIG. 1 and FIG. 2 depict interactions between GSP and MIS. FIG. 1 shows a preferred embodiment of GSP using MIS. M and SP indicate states of MIS apparatus and GSP, respectively. Inputs to the search processor are source structure Sand target structure T. S and T are also used by MIS. During the operation of GSP, it interacts with MIS through its designed methods that are discussed later. GSP may use an iterative scheme where S and T are modified into related structures S′ and T′, respectively, across its many iterations. In this case, MIS has access to S′ and T′ as inputs to its methods. On the other hand, GSP provides methods for identifying elements of S, T, S′, and T′ that are to be used by MIS, and for testing independence between pairs of such elements. R designates a returned result in this diagram. A null result indicates the failure of GSP to find a substructure of the source S that is “equal” (or “isomorphic”, the term usually used in relevant literature) to the target T.

FIG. 2 details the operation of GSP using an iterative scheme. Step 201 starts the GSP process and accepts and validates inputs S and T. Step 202 initializes GSP as well as MIS. Here M and SP represent states associated with MIS and GSP. Iterative steps of GSP are shown in flowchart blocks 203, 204, 206, 207, 209, and 210. Step 205 is reached if GSP cannot proceed any further because it has decided that no solutions exist and it must return null result and stop. This may happen, for example, if intermediate structure S′ becomes empty. Step 208 indicates a successful search and returns the substructure R of S that corresponds to T. i.e. R is “equal” to T.

In the iterative scheme used to illustrate usage of MIS, iterative steps operate on intermediate structures S′ and T′ derived from S, T, and results of previous iterations. The current state of MIS, indicated throughout as M, is used in this derivation. Step 203 is the modification step that derives S′ and T′ at the beginning of each iteration. Step 204 decides if the current iteration may proceed or whether GSP should stop. Step 206 searches for T′ in S′ producing result R. It also appropriately marks S′ and T′ so that if R is empty then these markings can be used to identify an element of Sin step 209. If R is empty then there is a need for further iterations and GSP reaches step 209. Step 209 identifies an element of S that will be inserted into M in step 210. It uses S, S═, T, T′ and markings of S′ and T′ for such identification.

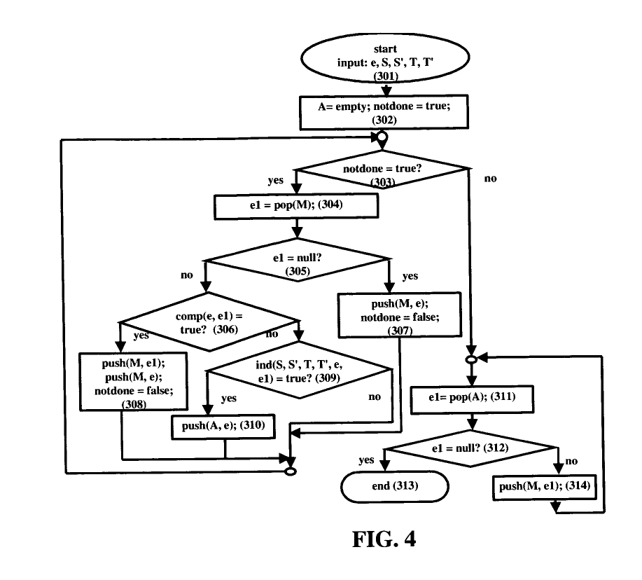

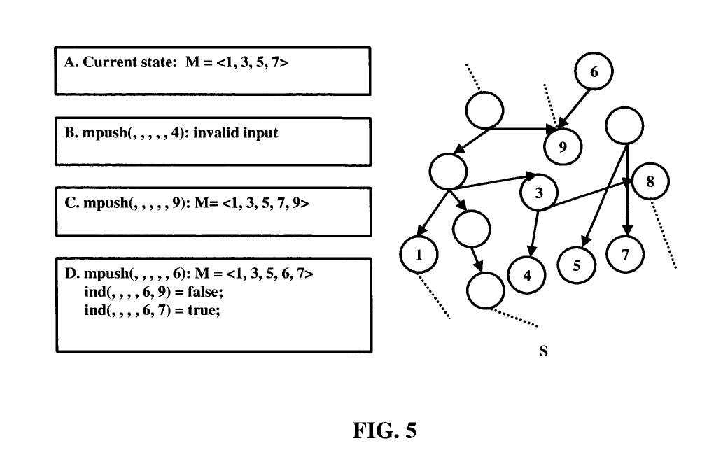

Step 210 uses the mpush( ) method provided by MIS. This step is further elaborated in FIG. 4 and FIG. 5 and will be discussed later in detail. Please note that the level of description of various steps taken by a GSP is intentionally kept abstract. For example, details of modify( ), search( ), and identify( ) methods of GSP are not provided. There are good reasons for doing so. Firstly, it helps to demonstrate key steps in GSP without delving deep into specifics of any single class of structures used by the search processor. This has the intended result of dealing with plurality of different classes of structures that may be used for S and T. Secondly, the main focus is on the MIS invention and GSP is described merely to understand the framework within which MIS may be embedded.

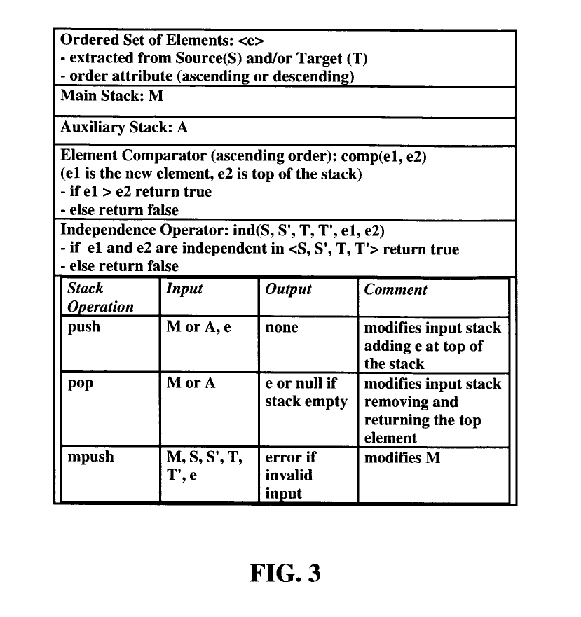

Monotonic Independent Stack. FIG. 3 enumerates essential parts of the MIS apparatus. MIS operates on elements provided to it by the embedding system, in our case GSP. These elements have uniquely defined order attributes. MIS consists of two standard stacks, the main stack M and an auxiliary stack A of elements. In addition, it has two operators, the comparator and the independence tester. These operators are denoted as comp( ) and ind( ).

M and A are standard stack structures of elements that typically provide two methods push( ) and pop( ). A standard stack of elements has a pointer to the top element and push( ) and pop( ) methods use this pointer for their operations. Method push( ) inserts an element at the top of the stack and the pop( ) method removes and returns the top element of the stack. In addition to containing M and A, and providing comp( ), ind( ), standard stack push( ) and pop( ) methods, MIS provides mpush( ) method. mpush( ) is the main method provided by MIS and used by emdedding system, in our case a GSP. This method operates upon both constituent stacks M and A.

Before describing components of MIS in detail, it should be pointed out that there is plurality of structure classes that a GSP may use to define S and T. A few of these were pointed out in the background section of this document. It is not possible to enumerate all these structure classes, though we may exemplify the plurality through a few example classes. These structures may include:
(1) orders,
(2) directed or undirected graphs,
(3) variety of specialized graphs, for example trees, line graphs, etc.,
(4) variety of specialized orders, for example partial orders, interval orders, semiorders, totally ordered sequences, etc.,
(5) labeled versions, where sets of labels are specified for nodes and/or edges of these structures.

As mentioned, elements used by MIS are provided to it by embedding GSP system through use of its mpush( ) method. Just as there is plurality of structures that may be used by GSPs, there is plurality of ways to define elements of structures used by GSPs. It is not possible to enumerate these different ways to define elements, though we may point out a few examples. Elements over structure class chosen for S and T by GSP may include:
(1) nodes, or sets or sequences of nodes,
(2) edges, or sets or sequences of edges,
(3) for graphs, connected subgraphs, or sets of disjoint subgraphs
(4) for orders, suborders, or sets of suborders.

An important property of a set of elements dynamically selected and passed to MIS by an embedding GSP system is that they are monotonically orderable. This is achieved by associating an order attribute that takes unique integer values for distinct elements. Monotonic ordering of elements could be either ascending or descending. In a graph structure, for example, if its nodes are chosen to be elements then unique node numbers associated with nodes may serve as values of order attributes. For another example, consider use of tree structures for S and T. If sub-trees are chosen to be elements then, for example, the unique node number associated with roots of these sub-trees may serve as values of order attributes for elements, provided it is guaranteed through choice of sub-trees as elements that no two sub-trees passed to MIS have common root nodes. In addition to order attribute, an element may have other attributes. For example, statistical values may be associated with elements.

Monotonic ordering of elements in the stack is achieved through use of comp( ) operator. This operator compares input elements e1 and e2 using their order attribute values. For monotonically ascending, or increasing, scheme for MIS, it returns true if order attribute value of e1 is greater than that of e2, returning false otherwise. On the other hand, for monotonically descending, or decreasing, scheme for MIS, it returns true if order attribute value of e1 is less than that of e2, returning false otherwise.

Independence of an ordered pair of elements is tested using ind( ) operator. In general, this operator takes as input S, S′, T, T′ and an ordered pair of elements <e1, e2>. Independence of such a pair of elements is defined by an embedding GSP. There is plurality of ways in which independence relationship may be defined between elements of an ordered pair. It is not possible to enumerate all different ways, but a few examples may be provided. Main categories of such relations usually deal with conditions over connectivity between elements or conditions over attribute values of elements. A few examples of independence relations for element pair <e1, e2> for directed graphs are as follows:
(1) Let elements be nodes, then there is a directed edge from e1 to e2.
(2) Let elements be nodes, then there is a path from e1 to e2.
(3) Let elements be edges, then e1 and e2 do not have a common node.
(4) Let elements be sets of nodes and let edges have positive weights, then the shortest path from any node of e1 to any node of e2 is greater than a constant value.

MIS has two standard stacks, M and A. Standard push( ) and pop( ) methods are used to manipulate these stacks. The principal method provided by MIS is mpush( ) which appropriately uses push( ) and pop( ) on M or A. Method mpush( ) is described in detail below.

Details of mpush( ) method. FIG. 4 depicts the operation of mpush( ) method of MIS as a flowchart. Ascending order of elements in MIS is used to specify the operation here. Changing the method comp(e, e1) of MIS to return true if e<e1 creates MIS with descending order of its elements. The starting step, 301, accepts inputs e, S, S′, T and T′ and validates them. In our iterative scheme for a GSP depicted in FIG. 2, it is called in step 210. S and T are original inputs to GSP and MIS and S′ and T′ are intermediate source and target structures obtained at the beginning of each iteration of GSP as shown in step 203 of FIG. 2. Element e is extracted using identify( ) method provided by GSPs as shown in step 209 of FIG. 2.

MIS uses auxiliary stack A for storing certain elements of M. Step 302 initializes auxiliary stack A of MIS to an empty stack. Method mpush( ) operates in two phases. In phase 1, it removes all elements of M that are greater than e, i.e. values of their order attributes are greater than the order attribute value of e and then pushes e on stack M. From the set of removed elements, those that are independent of e, as decided by ind( ) operator, are pushed into auxiliary stack A in the order that they are removed from M. In phase 2, all elements in A are iteratively popped from A and pushed onto M. At the end of phase 2, M contains a monotonically increasing set of elements of <S, S′, T, T′> that are pairwise independent. In FIG. 4, phase 1 is depicted in steps 303 through 310, and steps 311 through 314 constitute phase 2.

Step 303 checks if phase 1 should end. If not so, execution of mpush( ) reaches step 304. The top element e1 of M is popped using pop( ) method on M. If e1 is null indicating M is empty, condition tested in step 305, then execution reaches step 307 in which we push e into M and indicate termination of phase 1 by setting flag notdone to false. If the condition in step 305 fails then we compare e and e1 in step 306. If e is greater than e1 then a position in M has been found where e should be pushed. This is done in step 308. Here we push back e1 on M and then push e on the stack. We also indicate the end of phase 1 by setting flag notdone to false. If the test in step 306 fails then we check for independence of e and e1 in step 309. If they are independent then e1 is pushed into A in step 310 and phase 1 enters its next iteration. If they are not independent then e1 is discarded and phase 1 enters its next iteration.

At the beginning of phase 2, M contains a monotonically increasing set of elements, in bottom to top order of stack elements, with the top element being e. A contains a monotonically decreasing set of elements, in bottom to top order of stack elements. Also, any element of A is independent of and monotonically greater than any element of M. In phase 2, step 311 pops an element e1 of A. If A is not empty, checked in step 312 by testing if e1 is null, then e1 is pushed into M in step 314 and phase 2 continues. If the check in step 312 fails then phase 2 ends in step 313.

Example execution of mpush( ). FIG. 5 depicts a few examples of the operation of mpush( ) assuming a concrete scenario for a GSP. As mentioned before, for defining a concrete scenario, GSP must define the structure class of S and T that it accepts and define elements for the operation of embedded MIS. It must also specify methods for pairwise element comparison and independence testing. In the example depicted in FIG. 5, S and T are directed graphs. Elements are defined to be nodes of S. Each node has a unique node number in each of S and T, separately. MIS elements are ordered in ascending order from bottom of the stack M to its top. Node numbers are ordering attributes of nodes, i.e. comp(e, e1) is true if node number of e is greater than that of e1. The independence operator depends only on S and not on T, S′, and T′. Operator ind(S, , , , e1,e2) is true if there is a directed edge from e1 to e2 in S.

Given this concrete scenario for GSP, the behavior of mpush( ) method is exemplified in FIG. 5(A) through FIG. 5(D). (A) indicates the current configuration of stack M of MIS during some iteration of GSP operation. Here M has nodes of S with node numbers 1, 3, 5, and 7, in this order and with node number 7 being at the top of the stack. (B) shows an invalid input node number for mpush( ) method given the configuration in (A). Node number 4 is invalid because node 4 in S is not independent of node 3, currently in M, because there is a directed edge from node 3 to node 4 in S. This invalid input is detected and mpush( ) returns an error in step 301 of FIG. 4. (C) calls mpush( ) with valid input node 9. Since comp(9, 7) is true, mpush( ) method follows steps 301, 302, 303, 304, 305, 306, 308, 303, 311, 312, and 313 of FIG. 4, in this order, and the configuration of M becomes <1, 3, 5, 7, 9>. (D) calls mpush( ) with valid input node 6 with M configured as at the end of the mpush( ) call in (C). In this case, ind(S, , , , 6, 9) is false and ind(S, , , , 6, 7) is true. At the end of phase 1 of mpush( ), A has configuration <7> and M has configuration <1, 3, 5, 6>. Phase 2 pops node 7 from A and pushes it onto M. When mpush( ) terminates in step 313, M has monotonically increasing configuration of independent nodes of S denoted by <1, 3, 5, 6, 7> in (D).

An Example GSP Scenario Using Semiorders and Indifference Graphs. Finally, we cite a concrete scenario for an iterative GSP using semiorders for S and T. Semiorders form a specialized subclass of partial orders that have tree-like representations. Semiorders also correspond to specialized graphs called Indifference Graphs. Details of these structures are outside the scope of this document, though they are available in textbooks and in the provided reference and the bibliography contained there. No efficient solution was earlier known for GSPs with semiorders and or Indifference Graphs as defining structures for S and T. As indicated in the provided reference, even a partial use (Oust the monotonicity condition and not that for independence) substantially improved the execution time efficiency of these problems. Subsequent application of MIS using both monotonicity and independence conditions made the search process even more efficient (execution time being a polynomial function of the size of the input). A technical report on this result may be obtained from the author. This example is cited so as to claim the use of MIS (with use of both monotonicity and independence conditions) for solving search problems using labeled or unlabeled semiorders or indifference graphs as principal defining structure classes for source S and target T.

Although a preferred embodiment of the MIS invention is described here, there are many ways to embody the invention that preserve key ideas of the invention. It is apparent to those skilled and well versed in the art, where this invention belongs, that changes in form and presentation may be made without departing from the spirit and scope of ideas constituting the invention. Changes in form and presentation of key ideas may use the processes of memoization (converting primitive actions of an algorithm and input data into tabular form, independently or merged together, and then using this table), changes in representations, transformations, encodings, simulation, and execution. It is expected that this variability in form and presentation be appended to the claims that are presented next.

1. An apparatus and its methods to maintain a monotonically ordered list of independent elements, used either as an independent apparatus or by embedding one or multiple copies of it in another system, and consisting of and using:
a standard stack or other equivalent structure to maintain a monotonically ordered and independent list of elements;
auxiliary stacks or equivalent structures to temporarily store elements;
and comprising of one or more of the following steps:
the step of comparing elements using the values of order attributes of elements to order them in either increasing or decreasing order;
the step of testing pairwise independence of two elements using predefined criteria, with or without the use of auxiliary structures, during use of this apparatus;
the step of discarding certain elements if not independent;
the step of separately storing independent elements;
the step of restoring separately stored elements into the main monotonically ordered list of independent elements.

2. Claim 1 restricted to a search system embedding MIS, where the system is either iterative or non-iterative concrete generalized search processor embedding one or multiple copies of the MIS apparatus, and the processor defines and/or decides the following:
its own structure class for input source from plurality of available and possible structure classes;
its own structure class for input target from plurality of available and possible structure classes;
its own definition of attributes and labels and their multiplicity for primitive constituents, for example nodes and edges, of structures chosen for the source and the target inputs;
its own way of defining and choosing elements from plurality of ways to define and choose elements;
its own way of assigning order attribute values to elements;
its own way of defining and deciding independence between any pair of chosen elements from plurality of ways to define and decide this binary relationship.

3. Claim 1 and claim 2 restricted to the following:
structure class chosen by the search processor for the source and the target inputs is the class of semiorders;
structure class chosen by the search processor for the source and the target inputs is the class of indifference graphs;
structure classes chosen by the search processor for the source and the target inputs are such that the search problem with this choice of structure classes may be equivalently and efficiently (in polynomial time) reduced to the search problem which chooses semiorders as representative structure classes for the source and the target inputs.
